(19) United States
(12) Patent Application Publication
(10) Pub. No.: US 2009/0289955 A1
(43) Pub. Date: Nov. 26, 2009

(54) REALITY OVERLAY DEVICE

(75) Inventors: Stephan Douris, San Jose, CA (US); Marc Perry, San Francisco, CA (US); Barry Crane, Menlo Park, CA (US); Chris Kalaboukis, Los Gatos, CA (US); Athellina Athsani, San Jose, CA (US)

Correspondence Address: Weaver Austin Villeneuve & Sampson - Yahoo!, P.O. BOX 70250, OAKLAND, CA, 94612-0250, US

(73) Assignee: Yahoo! Inc.

(21) Appl. No.: 12/125,877

(22) Filed: May 22, 2008

(51) Int. Cl. G09G 5/12

(52) U.S. Cl. 345/630

(57) ABSTRACT

Disclosed are methods and apparatus for capturing information that is pertinent to physical surroundings with respect to a device, the information including at least one of visual information or audio information. Overlay information for use in generating a transparent overlay via the device is obtained using at least a portion of the captured information. The transparent overlay is then superimposed via the device using the overlay information, wherein the transparent overlay provides one or more transparent images that are pertinent to and in correlation with the physical surroundings.

### BACKGROUND OF THE INVENTION

The present invention relates generally to a computer implemented device capable of generating an overlay in correlation with physical surroundings being viewed through the device.

A variety of devices may be used by a user to access information. For example, wireless devices such as a wireless phone may be used to access information via the Internet. As another example, personal navigation devices may be used to obtain directions to a particular destination.

Unfortunately, devices that are currently available typically require a user to transmit a request for information in order to receive the desired information. Moreover, since the user must generally interact with such a device, the user may have difficulty performing other tasks such as driving or walking while interacting with the device. As a result, even if a user would like to obtain information from such a device, it may be difficult or unsafe for the user to do so.

In view of the above, it would be beneficial if a device could be used by a user to receive information that is pertinent to their surroundings while reducing distractions to the user.

### SUMMARY OF THE INVENTION

Methods and apparatus for implementing a reality overlay device are disclosed. A reality overlay device may be implemented in a variety of forms. In one embodiment, the reality overlay device is a wearable device that may be worn on the face of the user of the device. Through the use of a reality overlay device, a user may perceive an overlay that is superimposed over the user's physical surroundings. The overlay may include a visual transparent overlay in correlation with the physical surroundings as viewed by the user through the reality overlay device. Moreover, the overlay may also include an audio overlay that generates sounds that are not present in the physical surroundings.

In accordance with one embodiment, a reality overlay device automatically captures information that is pertinent to physical surroundings with respect to the device, the information including at least one of visual information or audio information. Overlay information for use in generating a transparent overlay via the device is automatically obtained using at least a portion of the captured information. The transparent overlay is then automatically superimposed via the device using the overlay information, wherein the transparent overlay provides one or more transparent images that are pertinent to and in correlation with the physical surroundings.

In accordance with another embodiment, a network device may receive information that is pertinent to physical surroundings with respect to a reality overlay device, the information including at least one of visual information or audio information. The network device may obtain overlay information for use in generating a transparent overlay via the reality overlay device using at least a portion of the captured information, where the transparent overlay provides one or more transparent images that are pertinent to and in correlation with the physical surroundings. The network device may then transmit the overlay information to the reality overlay device. For example, the network device may be implemented as a server associated with a web site.

In accordance with yet another embodiment, the overlay information may include audio overlay information. More particularly, an audio overlay may be generated using audio overlay information that has been obtained using at least a portion of the information that has been captured by the reality overlay device.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example reality overlay device in which various embodiments may be implemented.

FIG. 2 is a process flow diagram illustrating an example method of presenting an overlay via a reality overlay device such as that presented in FIG. 1.

FIG. 3 is a process flow diagram illustrating an example method of providing information to a reality overlay device such as that presented in FIG. 1.

FIG. 4 is a diagram illustrating an example maps view that may be presented in accordance with various embodiments.

FIG. 5 is a diagram illustrating an example local view that may be presented in accordance with various embodiments.

FIG. 6 is a diagram illustrating an example social view that may be presented in accordance with various embodiments.

FIG. 7 is a diagram illustrating an example green view that may be presented in accordance with various embodiments.

FIG. 8 is a diagram illustrating an example customized view that may be presented in accordance with various embodiments.

FIG. 9 is a simplified diagram of a network environment in which specific embodiments of the present invention may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The disclosed embodiments support the implementation of a reality overlay device that may be used by a user to receive information that is pertinent to the physical surroundings of the user. More specifically, the reality overlay device enables an overlay to be superimposed onto a real-world view that is perceived by a user of the device. The overlay may include an audio overlay and/or a transparent visual overlay. Specifically, the transparent visual overlay may be displayed such that it overlays the field of vision of the wearer of the overlay device.

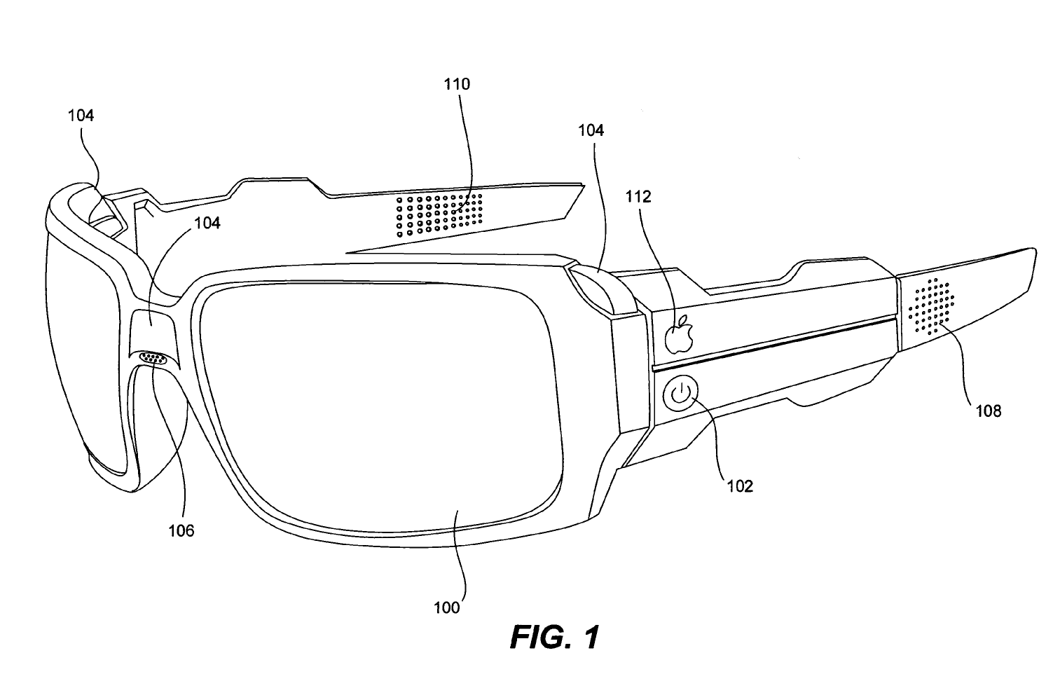

FIG. 1 is a diagram illustrating an example reality overlay device in which various embodiments may be implemented. In one embodiment, the reality overlay device is a device that is wearable by the user of the device. In this example, the reality overlay device is shaped in the form of glasses or sunglasses that a user may wear. More specifically, the reality overlay device may include one or more transparent lenses 100 that enable a user to view his or her surroundings through the transparent lenses 100. Specifically, the transparent lenses 100 may function as screens that enable a transparent overlay to be displayed. In some embodiments, the lenses 100 may become opaque in order for the viewer to perform various tasks such as word processing functions and/or viewing of movies. In one embodiment, each of the lenses 100 may include a liquid crystal display (LCD).

The reality overlay device may support connection to a wireless network such as a cell phone network, localized Bluetooth™ devices, Worldwide Interoperability for Microwave Access (Wi-MAX) and Wireless Fidelity (Wi-Fi). In addition, the device may support other communication mechanisms such as Universal Serial Bus (USB), etc. A start button 102 may enable the user to turn the reality overlay device on (or off). In one embodiment, when the reality overlay device is off, the device may be used as a pair of sunglasses. When the reality overlay device is on, the device may receive and capture information that is pertinent to physical surroundings with respect to the reality overlay device, enabling an overlay to be generated via the reality overlay device. For instance, the information that is captured may include visual and/or audio information.

The visual information may be captured via one or more visual inputs such as visual sensors 104. For instance, each of the visual sensors 104 may be a still or video camera that is capable of capturing one or more still images or video images, respectively. These images may be captured in two-dimensional form or three-dimensional form. In one embodiment, the visual sensors 104 may include two sensors, where one of the sensors 104 is positioned at the left side of the lenses 100 of the reality overlay device and another one of the sensors 104 is positioned at the right side of the lenses 100 of the reality overlay device. For instance, the sensors 104 may be placed near the hinges of the reality overlay device, as shown. In this manner, the two sensors 104 may capture images that would be viewed by a user's left and right eyes. The images captured via the two sensors 104 may be combined to replicate a single image that would be perceived by a user viewing the two separate images through the two different lenses 100. The visual sensors 104 may further include a third sensor at the center of the lenses 100 of the reality overlay device. In this manner, a transparent overlay may be generated and displayed in direct correlation with objects being viewed by the user.

The audio information may be captured via one or more audio sensors. For instance, the audio sensors may include one or more microphones. As shown in this example, one or more microphones 106 may be provided on the bridge of the reality overlay device for purposes of capturing voice commands from a user of the reality overlay device and/or surrounding sounds. Moreover, the reality overlay device may also support voice recognition to assist in capturing voice commands. The audio sensors may also include one or more sound captors (e.g., microphones) 108 at various locations on the reality overlay device. In this example, the sound captors 108 include two different sound captors, where each of the sound captors is positioned on the external side of one of the arms of the reality overlay device. The sound captors 108 may function to receive sounds from the surroundings (e.g., rather than the user of the device).

The information that is captured by the device may also include information such as a location of the device (e.g, coordinates of the device), an orientation of the device, or a speed with which the device is traveling. For example, the reality overlay device may include a global positioning system (GPS) device to enable coordinates of the reality overlay device to be determined. As another example, the reality overlay device may include one or more gyroscopes that may be used to determine an orientation of the reality overlay device. As yet another example, the reality overlay device may include an accelerometer that may be used to determine a speed with which the reality overlay device is traveling.

Other information that may be captured by the device may include identifying one or more entities in the field of vision of the reality overlay device. For instance, the reality overlay device may support pattern recognition. Thus, the reality overlay device may process at least a portion of the received information (e.g., one or more images) in order to identify one or more entities using pattern recognition. Such entities may include environmental features such as a mountain, road, building, or sidewalk. Moreover, entities that are recognized may also include people or animals. Pattern recognition may also be used to identify specific buildings by identifying letters, words, or addresses posted in association with a particular building. In addition, the device may enable entities to be recognized by a Radio Frequency Identification (RFID) or similar hardware tag. Similarly, entities may be recognized using the location of the device and orientation of the device.

The reality overlay device may obtain overlay information for use in generating and providing a transparent visual overlay and/or audio overlay via the device using at least a portion of the information that the reality overlay device has captured. The overlay information may be obtained locally via one or more local memories and/or processors. The overlay information may also be obtained remotely from one or more servers using an Internet browser via a wireless connection to the Internet. More specifically, in order to obtain the overlay information, the reality overlay device or a remotely located server may identify one or more entities in the information that the reality overlay device has captured. This may be accomplished by accessing a map of the location in which the reality overlay device is being used, using RFID, and/or by using pattern recognition, as set forth above. Information that is pertinent to the identified entities may then be obtained.

The overlay information may also specify placement of visual overlay information within the transparent visual overlay (e.g., with respect to identified entities). More specifically, the location of the entities in the visual information may be used to determine an optimum placement of the visual overlay information within the transparent visual overlay. For example, where one of the entities is a restaurant, the visual overlay information associated with the restaurant may be placed immediately next to or in front of the restaurant. As another example, where one of the entities is a road, directions or a map may be placed such that the road in the user's field of vision is not obstructed.

The reality overlay device may superimpose the transparent overlay via the device using the overlay information via one or more of the lenses 100, wherein the transparent overlay provides one or more transparent images (e.g., static or video) that are pertinent to the physical surroundings. The positioning of the transparent images may depend upon the location of any identified entities in the user's field of vision (e.g., to reduce obstruction of the user's field of vision). The transparent images that are produced may include text, symbols, etc. The transparent images may be generated locally or remotely. In this manner, a user of the reality overlay device may view real world images through the lenses 100 while simultaneously viewing the transparent overlay.

Similarly, in accordance with various embodiments, audio overlay information may be provided via one or more audio outputs (e.g., speakers) of the reality overlay device. In this example, the reality overlay device includes a headphone 110 that includes a speaker on the internal side of both the left and right arms of the reality overlay device. In this manner, a user may receive audio overlay information such as directions that would not impact the user's field of vision.

The reality overlay device may further include a visual indicator 112 that signals that the user is online or offline. The visual indicator 112 may also be used to indicate whether the user is on a wireless call.

The identity of the user of the device may be ascertained and used in various embodiments in order to tailor the operation of the device to the user's preferences. An identity of the user (e.g., owner) of the device may be statically configured. Thus, the device may be keyed to an owner or multiple owners. In some embodiments, the device may automatically determine the identity of the user (e.g, wearer) of the device. For instance, a user of the device may be identified by deoxyribonucleic acid (DNA) and/or retina scan.

It is important to note that the reality overlay device shown and described with reference to FIG. 1 is merely illustrative, and therefore the reality overlay device may be implemented in different forms. Moreover, the reality overlay device may support some or all of the above listed features, as well as additional features not set forth herein.

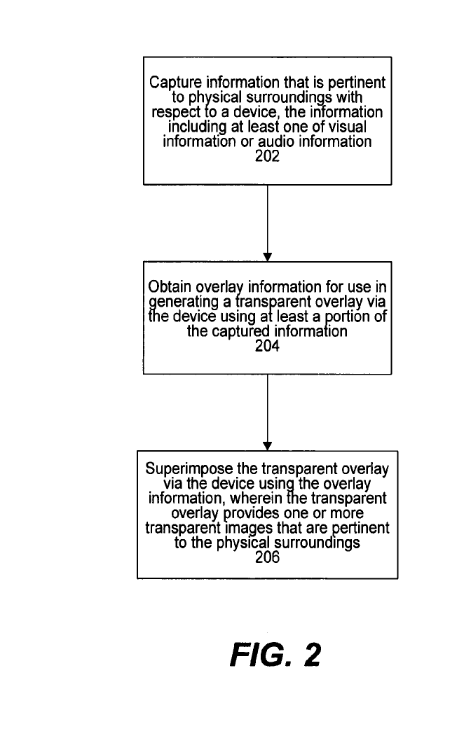

FIG. 2 is a process flow diagram illustrating an example method of presenting an overlay via a reality overlay device such as that presented in FIG. 1. The reality overlay device captures information that is pertinent to physical surroundings with respect to the reality overlay device at 202, where the information includes at least one of visual information or audio information. As set forth above, the visual information may include one or more images. The information that is received may further include a location of the device, orientation (e.g., angle) of the device with respect to one or more axes, and/or speed with which the device is moving, etc.

The reality overlay device obtains overlay information for use in generating a transparent overlay via the device using at least a portion of the captured information at 204. Overlay information may include a variety of information that may be used to generate a transparent overlay. Thus, the overlay information may include, but need not include, the actual transparent image(s) to be displayed in order to superimpose the transparent overlay. In order to obtain the overlay information, one or more entities in the surroundings or in nearby locations may be identified in the captured information. For example, entities such as businesses, other buildings or physical landmarks may be identified using pattern recognition software, RFID and/or GPS location. Similarly, individuals may be identified using technology such as RFID or other forms of signals transmitted by another individual's device.

The overlay information that is obtained may include information that is pertinent to the identified entities. For instance, the overlay information may include directions to the identified entities, maps, descriptions, reviews, advertisements, menus, offers, etc. Moreover, the overlay information may indicate a placement of one or more transparent images (e.g., advertisements, menus, maps, directions, reviews) with respect to and in correlation with the identified entities in the captured information (e.g., visual information), as perceived by the user of the reality overlay device.

The overlay information may also be obtained using user information associated with a user of the device. For instance, information such as the identity of the user, preferences of the user, friends of the user, and/or a history of purchases of the user may be used to obtain the reality overlay information.

The overlay information may be obtained locally via a memory and/or remotely from a server via the Internet. For instance, pattern recognition capabilities may be supported locally or remotely at a remotely located server. The overlay information may identify one or more entities such as physical locations, buildings, or individuals, as well as information associated with these entities. Moreover, the overlay information may include directions or maps in the form of text, arrows and/or other indicators associated with such entities.

The content of the overlay information is not limited to the examples described herein, and a variety of uses are contemplated. For instance, the overlay information may identify restaurants that the user may be interested in within the context of the surroundings. Similarly, the overlay information may include additional information associated with various entities, such as menus, advertisements, etc.

The reality overlay device may then superimpose the transparent overlay via the device using the overlay information, wherein the transparent overlay provides one or more transparent images that are pertinent to the physical surroundings at 206. The transparent images may be static images or video images. Moreover, the transparent images may be two-dimensional or three-dimensional images. The overlay may be provided for use in a variety of contexts. For example, a transparent image providing directions to destinations such as restaurants that may interest the user may be provided via the reality overlay device. As another example, a transparent image may be used to provide a menu of a restaurant. Alternatively, the transparent images may be provided in the form of video. The steps 202-206 performed by the reality overlay device may be performed automatically by the reality overlay device. In other words, the reality overlay device operates without requiring a user to input information or otherwise request information.

The reality overlay device may record captured visual and/or audio information, as well as corresponding superimposed transparent overlays in a local memory. In this manner, the user may store and later view real-life experiences with the benefit of superimposed transparent overlays. Thus, the device may display such recordings including captured information and associated superimposed visual and/or audio overlays.

The reality overlay device may also receive user input that is pertinent to the transparent overlay. For example, where the transparent overlay presents a menu for a restaurant, the user may choose to order from the menu. The reality overlay device may process the user input and/or transmit the user input to another entity such as an entity that has been identified in the previously captured visual information. For example, the reality overlay device may transmit the user's order to the restaurant.

The reality overlay device may receive user input via a variety of mechanisms via a physical or wireless connection. More particularly, the reality overlay device may receive a voice command from the user or a command received via another mechanism (e.g., hand movement or other gestures). Moreover, user input may also be captured via DNA, an eye focus tracking mechanism, a retina scan, an associated keyboard such as a bluetooth keyboard, other Bluetooth enabled devices, bar code scanners, RFID tags, etc.

Similarly, the reality overlay device may be connected to another device via a physical or wireless connection for providing output. For instance, the reality overlay device may be connected to a television in order to display captured images (and/or any associated audio information) and/or pertinent transparent overlays (and any/or associated audio overlays). As another example, users of different overlay devices may connect to one another for purposes of sharing the same experience (e.g., visiting a city or playing a game).

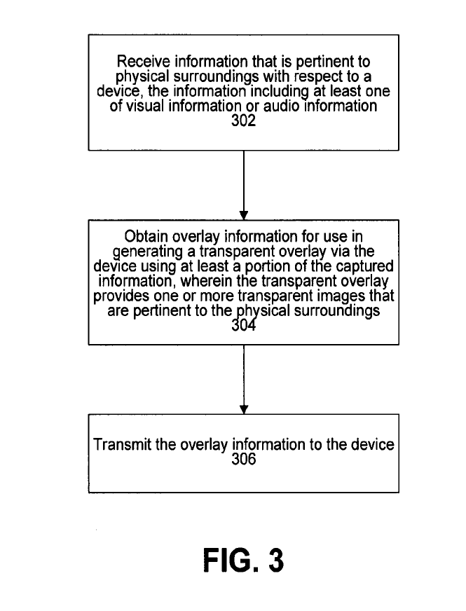

FIG. 3 is a process flow diagram illustrating an example method of providing information to a reality overlay device such as that presented in FIG. 1. A server may receive information that is pertinent to physical surroundings with respect to a device from the device at 302, where the information includes at least one of visual information or audio information. More specifically, the server may receive at least a portion of the information that has been captured by the reality overlay device. As set forth above, the information that is pertinent to the surroundings with respect to the device may include at least one of a location of the device, an orientation of the device, or a speed with which the device is traveling. The server may also receive user information associated with a user of the device.

The server may obtain (e.g., retrieve and/or generate) overlay information for use in generating a transparent overlay via the device using at least a portion of the captured information and/or at least a portion of any user information that has been received at 304, wherein the transparent overlay provides one or more transparent images that are pertinent to the physical surroundings. For instance, the server may identify one or more entities in the visual information using at least a portion of the received information. Thus, the server may support pattern recognition, as well as other features. The server may obtain information that is pertinent to the identified entities (e.g., from one or more databases) and/or ascertain a desired placement of the overlay information with respect to the identified entities, where the overlay information indicates the desired placement of visual overlay information within the transparent overlay. The server may then transmit the overlay information to the device at 306.

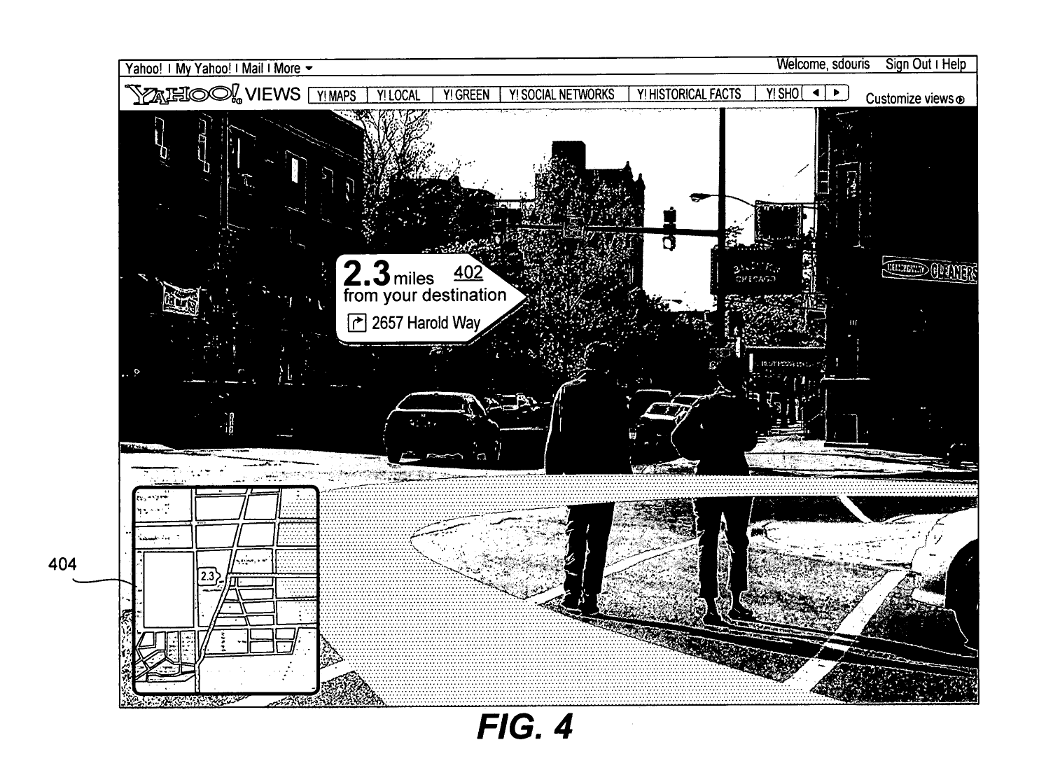

The reality overlay device may be used to generate a transparent overlay for use in a variety of contexts. Examples of some of these uses will be described in further detail below with reference to FIGS. 4-8.

FIG. 4 is a diagram illustrating an example maps view that may be presented in accordance with various embodiments. As shown in this example, the maps view can indicate a distance and/or direction to a destination (e.g., wavepoint) via text and/or symbols. For example, a “virtual” road sign 402 may be presented in a location of the transparent overlay such that the virtual road sign 402 is in a “safe” empty space in the user's field of vision. As set forth above, the virtual sign may be placed such that it is clear and does not impinge on the user's ability to drive or walk while wearing the reality overlay device. Moreover, the virtual road sign 402 may be provided in a specific color such that it is clear that the virtual road sign 402 has been overlaid over the “real” image that the user is viewing through the reality overlay device. As another example, the transparent overlay may include a map 404 or other geographic information. Virtual road signs 402 and/or other geographic information 404 may be displayed such that the user's vision will not be impeded. For instance, the transparent overlay may display virtual road signs 402 and/or geographic information such as maps 404 along the ground (e.g., sidewalk and/or road) as identified in the visual information that has been captured via the reality overlay device.

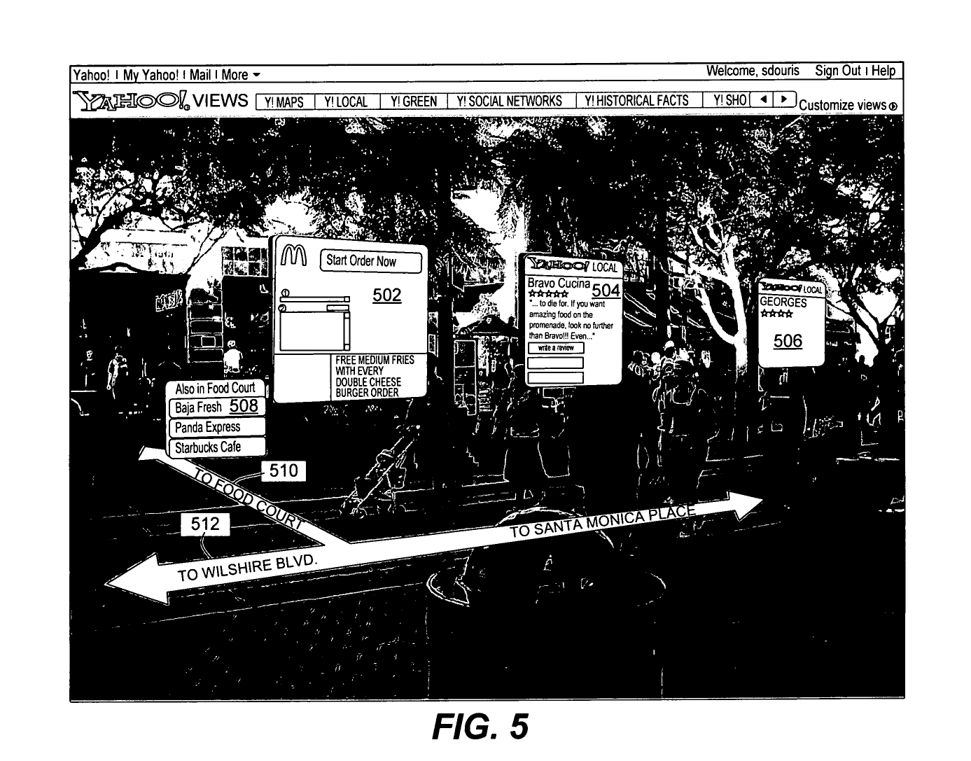

FIG. 5 is a diagram illustrating an example local view that may be presented in accordance with various embodiments. As shown in the local view, the transparent overlay that is superimposed by a reality overlay device may include one or more virtual billboards. Each of the virtual billboards may be placed in close proximity to a business or entity with which it is associated. For instance, a virtual billboard may be placed such that it is overlaid next to and/or in front of a business in the user's field of vision. Thus, the overlay information may indicate placement of each of the virtual billboards with respect to a corresponding business.

In this example, the transparent overlay includes three different virtual billboards, which are placed in front of a business with which it is associated, such as a restaurant. The first virtual billboard 502 is a billboard associated with a McDonald's restaurant, the second virtual billboard 504 is a billboard associated with Bravo Cucina restaurant, and the third virtual billboard 506 is associated with Georges restaurant 508. As shown at 502, a virtual billboard may provide an advertisement, menu and/or additional functionality. For instance, a user may place an order to the business via the associated virtual billboard and/or pay for the order electronically, enabling the user to walk into the business and pick up the order. As one example, the user may place the order via a voice command such as “place order at McDonalds.” As another example, the user of the reality overlay device may virtually touch a “Start Order Now” button that is displayed in the transparent overlay by lifting his or her hand into the user's field of vision. In this manner, the user may silently interact with the reality overlay device using a gestural interface. Such physical movements may also be used to modify the transparent overlay. For instance, the user may “grab and pull” to increase the size of a virtual billboard or menu, or “grab and push” to reduce the size of a virtual billboard or menu.

In addition, as shown at 504 and 506, a virtual billboard may display additional information associated with a business. For instance, a virtual billboard may display user reviews of an associated business. These user reviews may be retrieved from a database storing user reviews.

A virtual billboard may merely include a name of one or more business establishments, as shown at 508. More specifically, a virtual billboard may include a name of the business, as well as any other additional information. In this example, the virtual billboard 508 advertises a Food Court, as well as the names of the restaurants in the Food Court. In this manner, additional restaurants within a specific distance (e.g., on the same block) may be advertised.

A transparent overlay may also include directions to a business establishment associated with a virtual billboard. The directions may include one or more symbols and/or text. As shown at 510, an arrow and associated text provide directions the Food Court advertised by the virtual billboard shown at 508. More specifically, the directions provided at 510 are shown such that the directions 510 overlay the ground (e.g., sidewalk and/or street). In this manner, directions may be placed in a location of the transparent overlay such that the user's view is not obstructed.

In this example, the virtual billboards are shown to be rectangular in shape. However, the size and/or shape of a virtual billboard may be determined based upon a variety of factors. For instance, the size and/or shape of a virtual billboard may be determined based upon the size of the image of the business in the visual information that has been captured, the number of virtual billboards to be displayed in the transparent overlay, user preferences and/or preferences of the business for which a virtual billboard is displayed.

The transparent overlay may also include geographic information, as set forth above with respect to FIG. 4. The geographic information may include one or more symbols and/or associated text. For instance, the geographic information may identify street names such as cross streets and/or other directions. As shown at 512, the geographic information includes cross street names, “Wilshire Blvd.” and “Santa Monica Place.”

Through the use of virtual billboards, the need for physical billboards, signs, and flyers may be eliminated. In this manner, pollution may be eliminated and the natural landscape may be preserved.

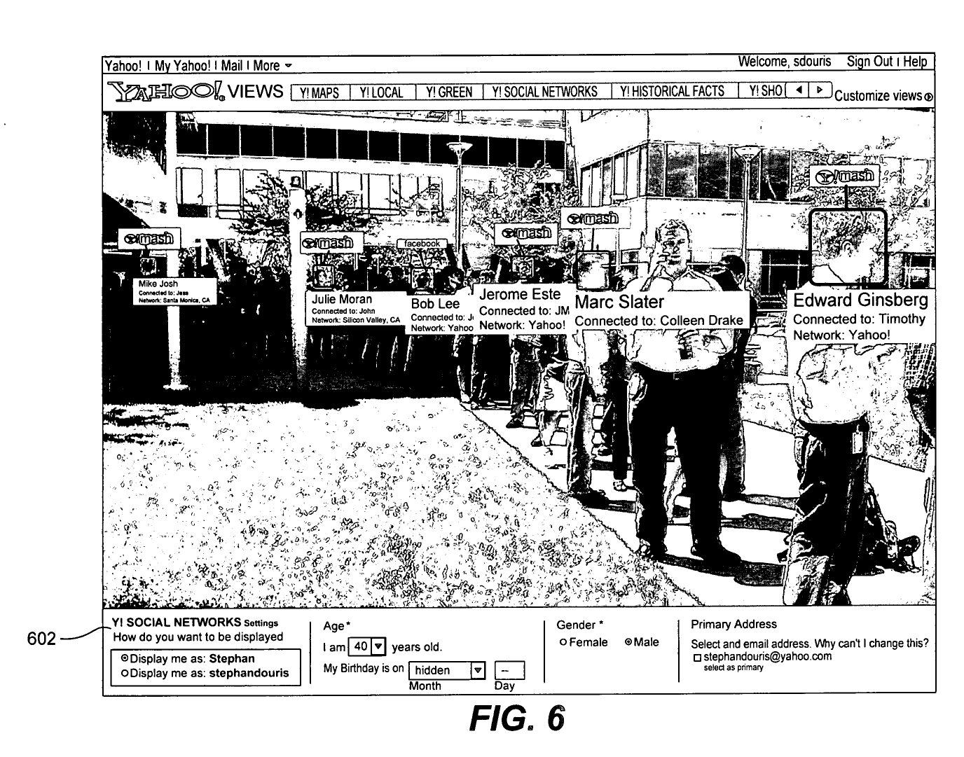

FIG. 6 is a diagram illustrating an example social view that may be presented in accordance with various embodiments. The social view may provide information associated with one or more individuals. As shown in this example, the information that is provided in the transparent overlay may include the name of one or more individuals being viewed, enabling the user to easily identify the individuals without remembering their names. In addition, the social view may also provide additional information associated with these individuals, such as an identity of a network to which the individual is connected and/or a connection (e.g., person to whom the individual is connected).

An individual may choose to be a member of a social network. Moreover, an individual may choose to reveal specific personal information to users of other reality overlay devices, as well as limit the information that is revealed by hiding specific information. This personal information 602 may be provided in a segment of the transparent overlay. In this example, the personal information 602 is provided at a bottom portion of the transparent overlay. For instance, the personal information 602 may include a display name, age, birthday, gender, and/or electronic mail address. A user may modify his or her personal information 602 by simply modifying one or more settings associated with the personal information 602.

Information associated with various individuals may be obtained from a remotely located server, locally from memory of the reality overlay device, and/or from devices of these individuals. For instance, such devices may transmit a signal indicating an identity of an individual such as the owner or user of the device, as well as other information associated with the individual. Moreover, the reality overlay device may retrieve information associated with the individual from a remotely located server and/or locally via information stored in a local memory of the reality overlay device.

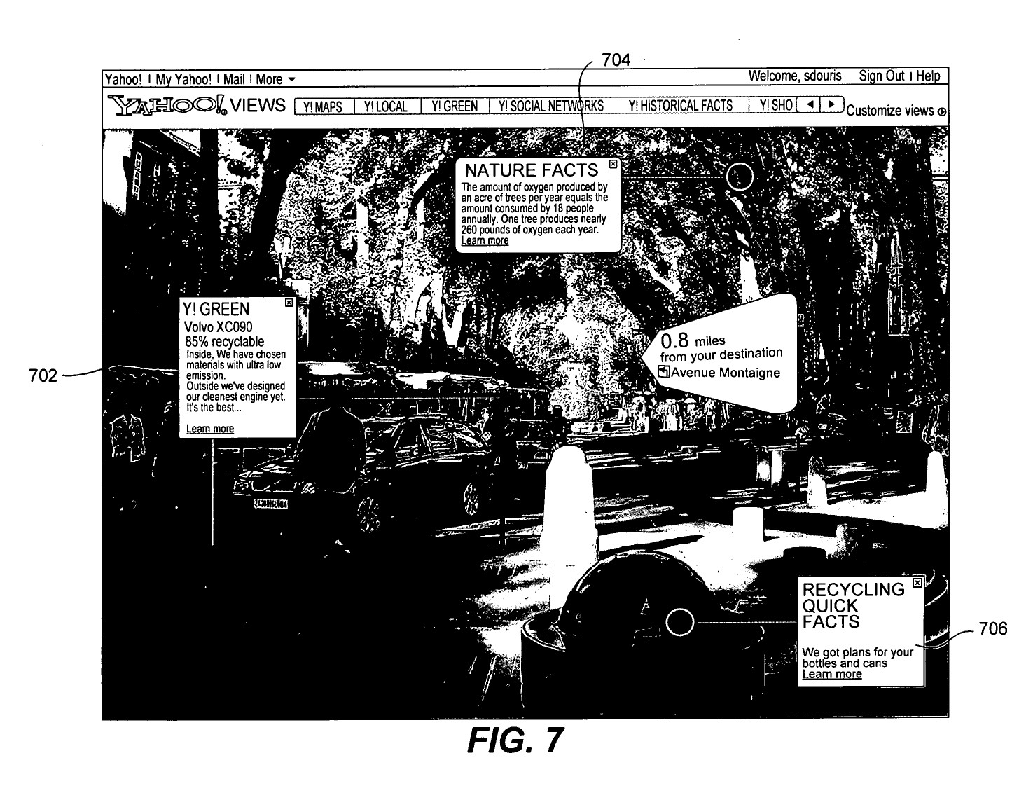

FIG. 7 is a diagram illustrating an example green view that may be presented in accordance with various embodiments. The green view may provide a transparent overlay that includes environmental information such as recycling facts. As can be seen in this example, the green view may include recycling information associated with a particular vehicle at 702. Such recycling information may indicate the level of emissions and/or the percentage of the materials in the vehicle that are recyclable. The green view may also include “nature facts” such as the amount of oxygen produced by trees, as shown at 704. The green view may also indicate locations 706 that receive recyclable materials.

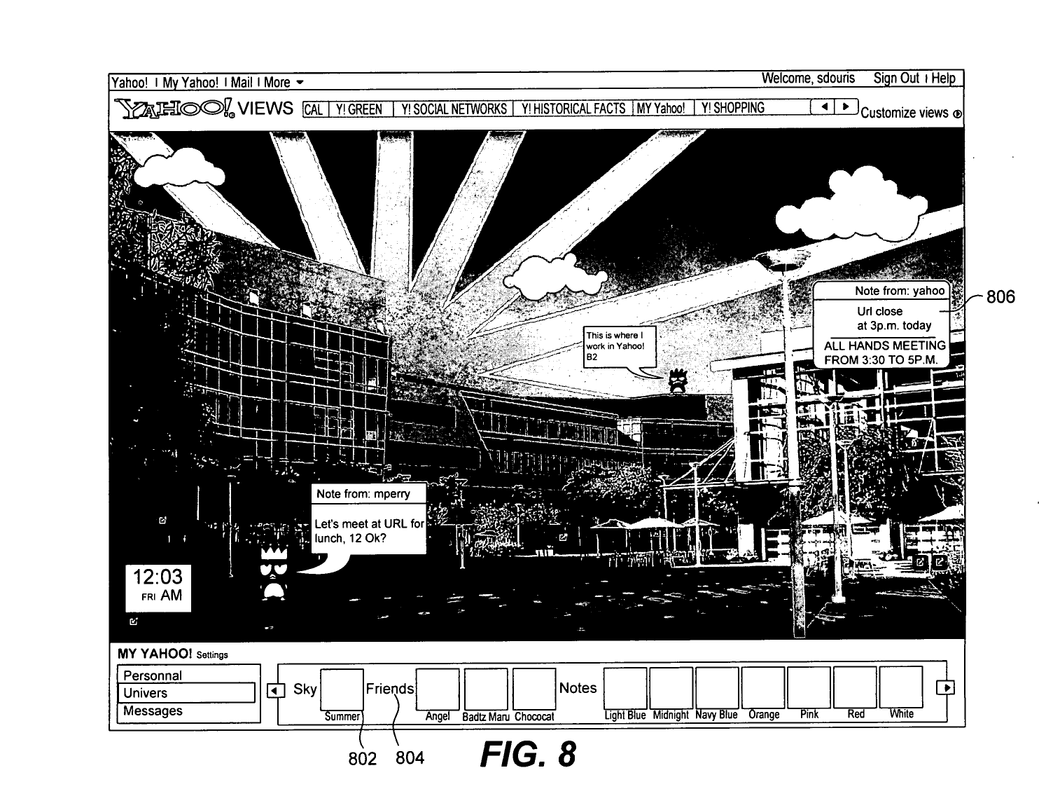

A variety of possible “views” provided by a transparent overlay may be generated in accordance with various embodiments of the invention. Moreover, such views may be customized based upon a user's preferences. FIG. 8 is a diagram illustrating an example customized view that may be presented in accordance with various embodiments. As shown in this example, a customized view may include weather information 802, social information 804 such as locations of friends of the user, events 806 and/or locations of such events. Moreover, a user may display a message directed to a specific set of one or more individuals. In this manner, a user's membership in a social network may be leveraged to display associated data in a manner that is most relevant to the user.

The above description refers to the generation of a visual transparent overlay. However, it is also important to note that information may also be provided audibly as well as visually. Thus, in some embodiments, audio information that is pertinent to the physical surroundings is generated from at least a portion of the captured information and provided via one or more audio inputs of the reality overlay device.

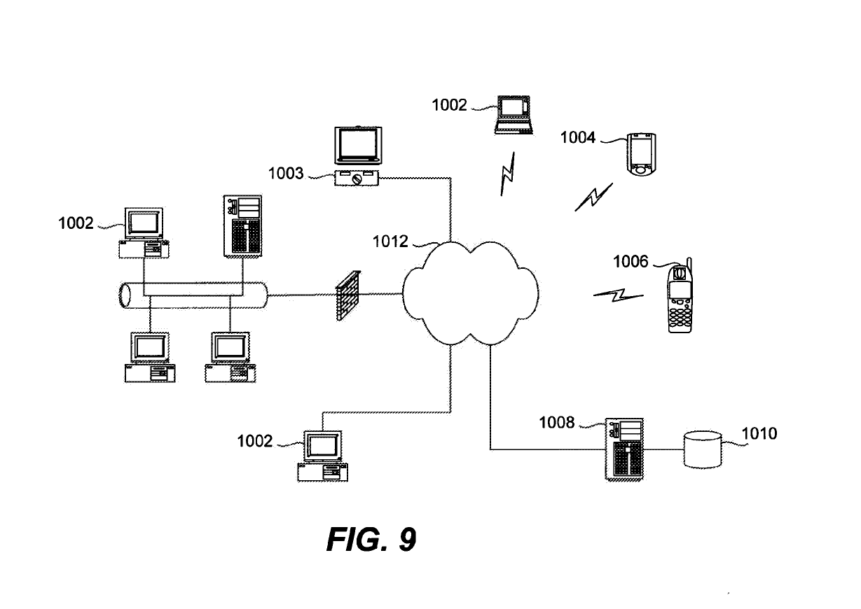

Embodiments of the present invention may be employed to support the operation of a reality overlay device in any of a wide variety of contexts. For example, as illustrated in FIG. 9, implementations are contemplated in which a user implementing a reality overlay device 1000 interacts with a diverse network environment which may include other reality overlay devices, any type of computer (e.g., desktop, laptop, tablet, etc.) 1002, media computing platforms 1003 (e.g., cable and satellite set top boxes and digital video recorders), handheld computing devices (e.g., PDAs) 1004, cell phones 1006, server 1008 or any other type of device.

And according to various embodiments, reality overlay information for use in generating an overlay (e.g., visual transparent overlay and/or audio overlay) in accordance with the disclosed embodiments may be obtained using a wide variety of techniques. For example, the reality overlay information may be obtained via a local application and/or web site and may be accomplished using any of a variety of processes such as those described herein. However, it should be understood that such methods of obtaining reality overlay information are merely examples and that the overlay information may be obtained in many other ways.

A web site is represented in FIG. 9 by the server 1008 and data store 1010 which, as will be understood, may correspond to multiple distributed devices and data stores. The invention may also be practiced in a wide variety of network environments (represented by network 1012) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations. Thus, computer-program instructions for performing various disclosed processes may be stored at the reality overlay device 1000, as well as the server 1008.

The disclosed techniques of the disclosed embodiments may be implemented in any suitable combination of software and/or hardware system, such as a web-based server used in conjunction with the disclosed reality overlay device. The reality overlay device or server of this invention may be specially constructed for the required purposes, or may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Regardless of the system's configuration, the reality overlay device 1000, the server 1008, and/or other devices in the network may each employ one or more memories or memory modules configured to store data, program instructions for the general-purpose processing operations and/or the inventive techniques described herein. The program instructions may control the operation of an operating system and/or one or more applications, for example. The memory or memories may also be configured to store data structures, maps, navigation software, virtual billboards, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
automatically capturing information that is pertinent to physical surroundings with respect to a device, the information including visual information;
automatically obtaining overlay information for use in generating a transparent overlay via the device using at least a portion of the captured information; and
automatically superimposing the transparent overlay via the device using the overlay information, wherein the transparent overlay provides one or more transparent images that are pertinent to and in correlation with the physical surroundings.

2. The method as recited in claim 1, wherein the overlay information is obtained using at least a portion of the captured information and user information associated with a user of the device.

3. The method as recited in claim 1, wherein the information that is pertinent to the surroundings with respect to the device includes at least one of a location of the device, an orientation of the device, or a speed with which the device is traveling.

4. The method as recited in claim 1, further comprising:
identifying one or more entities using at least a portion of the captured information;
wherein obtaining the overlay information includes obtaining information that is pertinent to the identified entities.

5. The method as recited in claim 1, wherein the overlay information indicates placement of visual overlay information within the transparent overlay such that the transparent overlay is correlated with the physical surroundings.

6. The method as recited in claim 1, further comprising:
identifying one or more entities using at least a portion of the captured information;
wherein superimposing the transparent overlay includes providing the one or more transparent images with respect to the identified entities.

7. The method as recited in claim 1, further comprising:
receiving user input that is pertinent to the transparent overlay; and
processing the user input or transmitting the user input to another entity.

8. A method, comprising:
receiving information that is pertinent to physical surroundings with respect to a device, the information including visual information;
obtaining overlay information for use in generating a transparent overlay via the device using at least a portion of the received information, wherein the transparent overlay provides one or more transparent images that are pertinent to and in correlation with the physical surroundings; and
transmitting the overlay information to the device.

9. The method as recited in claim 8, further comprising:
receiving user information associated with a user of the device;
wherein obtaining overlay information for use in generating a transparent overlay via the device includes obtaining the overlay information using at least a portion of the received information and at least a portion of the user information.

10. The method as recited in claim 8, wherein the information that is pertinent to the surroundings with respect to the device includes at least one of a location of the device, an orientation of the device, or a speed with which the device is traveling.

11. The method as recited in claim 8, further comprising:
identifying one or more entities using at least a portion of the received information;
wherein obtaining the overlay information includes obtaining information that is pertinent to the identified entities.

12. The method as recited in claim 8, further comprising:
identifying one or more entities using at least a portion of the received information; and
ascertaining a desired placement of the overlay information with respect to the identified entities;
wherein the overlay information indicates the desired placement of visual overlay information within the transparent overlay.

13. An apparatus, comprising:
a processor; and
a memory, at least one of the processor or the memory being adapted for:
automatically capturing information that is pertinent to physical surroundings with respect to the apparatus, the information including visual information;
automatically obtaining overlay information for use in generating a transparent overlay via the apparatus using at least a portion of the captured information; and
automatically superimposing the transparent overlay via the apparatus using the overlay information, wherein the transparent overlay provides one or more transparent images that are pertinent to and in correlation with the physical surroundings.

14. The apparatus as recited in claim 13, wherein the overlay information is obtained using at least a portion of the captured information and user information associated with a user of the apparatus.

15. The apparatus as recited in claim 13, wherein the information that is pertinent to the surroundings with respect to the device includes at least one of a location of the apparatus, an orientation of the apparatus, or a speed with which the apparatus is traveling.

16. The apparatus as recited in claim 13, at least one of the processor or the memory being further adapted for:
identifying one or more entities using at least a portion of the captured information;
wherein obtaining the overlay information includes obtaining information that is pertinent to the identified entities.

17. The apparatus as recited in claim 13, wherein the overlay information indicates placement of visual overlay information within the transparent overlay such that the transparent overlay is correlated with the physical surroundings.

18. The apparatus as recited in claim 13, at least one of the processor or the memory being further adapted for:
identifying one or more entities using at least a portion of the captured information;
wherein superimposing the transparent overlay includes providing the one or more transparent images with respect to the identified entities.

19. An apparatus, comprising:
a processor; and
a memory, at least one of the processor or the memory being adapted for:
receiving information that is pertinent to physical surroundings with respect to a device, the information including visual information;
obtaining overlay information for use in generating a transparent overlay via the device using at least a portion of the received information, wherein the transparent overlay provides one or more transparent images that are pertinent to and in correlation with the physical surroundings; and
transmitting the overlay information to the device.

20. A computer-readable medium storing thereon computer-readable instructions, comprising:
instructions for receiving information that is pertinent to physical surroundings with respect to a device, the information including visual information;
instructions for obtaining overlay information for use in generating a transparent overlay via the device using at least a portion of the received information, wherein the transparent overlay provides one or more transparent images that are pertinent to and in correlation with the physical surroundings; and
instructions for transmitting the overlay information to the device.
